(19) United States
(12) Patent Application Publication
(10) Pub. No.: US 2007/0071938 A1
(43) Pub. Date: Mar. 29, 2007

(54) Seal device for painting machine

(76) Inventor: Shigemitsu Kawazoe, Naka-ku (JP)

Correspondence Address: STRAUB & POKOTYLO, 620 TINTON AVENUE, BLDG. B, 2ND FLOOR, TINTON FALLS, NJ, 07724, US

(21) Appl. No.: 11/339,305

(22) Filed: Jan. 25, 2006

(30) Foreign Application Priority Data
Sep. 27, 2005 (JP) 279206/2005

(51) Int. Cl. B32B 3/02

(52) U.S. Cl. 428/66.4

(57) ABSTRACT

Disclosed is a seal device for painting machine having good sealing performance over a long time and durable, thereby eliminating the need for frequent maintenance operations and minimizing leakage of paint or the like. The seal device 10 is a two-part structure comprising a seal ring 20 of relatively low resiliency and a pre-pressurize member 30 of relatively high resiliency. The seal ring 20 comprises a pair of opposed arms 25 , 26 at both sides of a groove 24 preferably a substantially composite UV-shape in cross section. A base portion 37 of the pre-pressurize member 30 having substantially the same cross sectional shape as the groove 24 is of the groove 24. By applying a pressure onto the pressure portion 38 of the pre-pressurize member 30 extending from the seal ring 20, the arms 25, 26 of the seal ring 20 are deflected outwardly for better sealing.

### BACKGROUND OF THE INVENTION

The present invention relates to a seal device, more specifically to a seal device for a painting machine to be used in a painting machine for spraying paint on an outer surface of an object to be painted such as, for example, automobile bodies for automobiles to be sequentially assembled in a production line.

It is typical that outer surfaces of various machines and appliances such as, for example, automobiles are covered with aluminum or other metal plates. Such outer surfaces are normally painted with paint for the purpose of securing durability by preventing such materials from staining or improving outer appearances. In particular, painting of automobiles or the like is performed with paint of one color or plural colors selected from a large number of colors depending on users' choice.

Painting of such automobiles or the like are carried out by melting paint in a liquid form (or in solution) with volatile solvent such as thinner, toluene or the like end sprayed from a nozzle on a surface to be painted by utilizing pressure of gas such as air or the like. Typically, painting is carried out more than one time by repeating a painting step and a drying step from an under painting to an upper (or a finish) painting of a desired thickness using the same or different paints.

Firstly, a brief description will be made about a typical painting machine with reference to FIG. 5 and FIG. 6. FIG. 5 shows the entire construction of a painting machine to be used for painting automobiles or the like. FIG. 6 is a schematic diagram for describing a painting operation of the painting machine as shown in FIG. 5.

In FIG. 5, the painting machine 70 comprises a main body (referred to as a painting robot hereunder) 71 having an arm 72 and an ejection control unit 74, a cartridge bell 73 disposed at the front end of the arm 72 of the painting robot 71, a cartridge transport unit 75, a plurality of cartridges 76, a paint filling unit 77, a bell cup washing unit 78 and the like.

The painting robot 71 of the painting. machine 70 freely moves the arm 72 in response to locations and shapes of the object to be painted under control of an internal controller (not shown) and paints the object by ejecting or spraying a predetermined amount of paint accommodated in the cartridge 6 in the cartridge bell 73 that is disposed at the front end of the arm 72 under control of the ejection control unit 74. The arm 72 of the painting robot 71 can be automatically controlled in the position and time by, for example, a program that is preinstalled in a CPU (Central Processing Unit) in the aforementioned controller.

The cartridge transport unit 75 is a unit for delivering a plurality of cartridges 76 containing, for example, different paints to the cartridge bell 73 disposed at the front end of the arm 72 of the painting robot 71. The paint filling unit 77 is a unit for filling a predetermined paint in the respective cartridge 76. The bell cup washing unit 78 washes the bell cup at the time of changing paints or their colors, thereby preventing plural paints from being mixed.

By the painting machine as shown in FIG. 5, the painting robot 71 is able to move to the optimum position in response to the size and the shape of the object to be painted and for painting a predetermined amount of paint. It is also possible to paint different paints for plural times at the same position of the object to be painted with a certain time interval between paintings. In this manner, desired paint (or paints) can be painted on the object to be painted in a predetermined sequence.

Now, a painting operation of the painting machine 70 will be described hereunder with reference to FIG. 6. A desired cartridge 76 is attached to the cartridge bell 73. A piston is accommodated in the cartridge together with paint 81. Also connected from the ejection control unit 74 is a pushing solvent tube 83. On the other hand, a turbine air tube 86 is connected to the cartridge bell 73 from a rotary controller 84 by way of an electric-air converter 85 and high voltage is also applied to object to be painted by way of a cable 88.

Upon sending solvent by way of the pushing solvent tube 83 under control of ejection control unit 74, the piston in the cartridge 76 is driven and ejects the paint 81 out of a nozzle at the front end of the cartridge bell 73, thereby uniformly spraying the ejected paint over the surface of the object to be painted 89. High voltage from the high voltage controller 87 electrically charged the paint and helps to uniformly spraying the paint over the predetermined surface of the object to be painted 89. In this manner, painting non-uniformity is effectively avoided and ensures the paint to be firmly adhered on the surface of the object to be painted 89.

Although not shown in the drawing, the painting machine 70 as described hereinabove uses a large number of seal devices in the cartridge bell 73 and the cartridge 76 for the purpose of preventing paints, air and solvent from leaking or escaping. Particularly, in painting machines for automobiles or the like, painting operations are repeated on different objects to be painted or even on the same object to be painted for under painting or upper painting while frequently replacing paints. Accordingly, it is required for the seal devices to be used therein to ensure a large number of painting operations while maintaining sufficient sealing performance.

Examples of conventional ring type seal device for allowing a shaft or rod to pass through their center openings are disclosed in some technical publications. For example, Japanese patent publication JP342-721B1 discloses a plate type seal device made from polytetrafluoroethylene and used by fixing at its peripheral part. Also, a seal device to be fixed at its peripheral part in a casing and used with a spring and a cover layer for preventing medium from escaping is disclosed in Japanese patent publication, JP354-14256B1.

Moreover, the applicant of this patent application has been making and selling ring type seal devices for painting machines under the trade name “V-Seal”. One example of such seal device for painting machine is shown in FIG. 7. The seal device for painting machine is a two parts structure comprising a seal ring 50 and an adaptor (pre-pressurize member) 60 made from a relatively hard (i.e., less resilient) material. FIG. 7 (A) shows a cross section view of the seal ring 50 constituting the V-Seal along the centerline. FIG. 7 (B) shows a cross section view of the adaptor 60. And FIG. 7 (C) shows a partial cross section view in the condition when the seal ring 50 is assembled with the adaptor 60.

As shown in FIG. 7 (A), the seal ring 50 constituting the V-Seal is generally ring shape (or doughnut shape) to be disposed in a casing (not shown) such as a cylinder or the like and has an opening 53 through which a shaft (or a tubular member) reciprocating in response to the painting operation passes. Describing more in details, the seal ring 50 has one surface (or upper surface) 51, the other surface (or lower surface) 52, an inner side surface 55 and an outer side surface 56. And the one surface 51 is slightly larger than the other surface 52, thus generally inverted frustum of cone as a whole. There is formed a generally V-shaped deep ring groove 54 in cross section is formed in the entire one surface 51. The angle of the groove 54 is, for example, about 60 degrees.

On the other hand, the adaptor 60 is generally ring shape having the diameter slightly smaller than that of the seal ring 50 and made from a rigid material. The adaptor 60 has one surface (or an upper surface) 61, the other surface (or a bottom surface) 62 that is slightly smaller in diameter than that of the one surface 61 and a center opening 63 that is larger in diameter than the opening 53 in the seal ring 50. The cross section at the lower portion 64 of the adaptor 60 is inverted trapezoidal.

When the seal device is in use, the seal ring 50 as shown in FIG. 5 (A) and the adaptor 60 as shown in FIG. 5 (B) are integrated or combined by inserting the lower portion 64 of the adaptor 60 into the groove 54 in the seal ring 50. In such using condition, the lower portion 64 of the adaptor 60 is pushed in the groove 54 in the seal ring 50 when pressure is applied onto the one surface 61 of the adaptor 60, thereby resisting the force applied onto the inner wall 55 and the outer wall 56 of the seal ring 50 and maintaining flexure of these walls 55 and 56. In this manner, the space between, for example, a movable shaft extending through the center opening in the seal ring 50 and the inner wall of a casing.

The conventional seal devices as disclosed in the abovementioned patent publications and the conventional V-Seal that the applicant of this patent application has been making and selling may tolerate for, for example, up to about several hundreds thousand to about 1 million painting operations (i.e., numbers of reciprocal movements of the shaft) only if proper materials are used and if they are precisely manufactured. However, if used in excess of such limit of painting operations, sealing performance deteriorates to such level of causing leakage or escape of fluid, i.e., paint, solvent, air or the like, thereby requiring replacement.

Painting process for automobiles or the like is normally automated by the use of aforementioned painting robots. However, periodic maintenance operations by a maintenance personnel are required in order to verify or inspect the sealing performance of the seal devices in the painting process and replacing the deteriorated seal devices. Such maintenance operations not only require considerable manpower but also interrupt painting operations during maintenance or replacement as well as waist of fluid, which results in significant reduction in working efficiency and increase production cost of the products. Particularly, since a large number of seal devices are used in a painting machine, deterioration or defect of even one seal device in such painting machine not only requires replacement and/or maintenance of such defective seal device but also waists leaked paint or the like. This is the reason why high durability and stability of such seal device are extremely important to a painting machine.

### SUMMARY OF THE INVENTION

In light of the above problems of the prior art, it is therefore an object of the present invention to provide a seal device for painting machine that maintains sealing performance over a long time and during a large number of painting operations and that can significantly improve efficiency by reducing the frequency of maintenance operations and minimizing leakage of paint or the like.

The seal device for painting machine according to the present invention is the one comprising a seal ring having an opening through which a shaft moving in response to painting operations for spraying paint from a container and a pre-pressurize member to be inserted into a groove formed in the seal ring, characterized in that: the seal ring is made from a material of relatively low resilient and low friction characteristics and is formed with a pair of arms at both sides of the groove in cross section across the groove; the pre-pressurize member is made from a relatively high resilient material and has a base portion to be inserted into the groove in the seal ring and a pressure portion extending from the seal ring; and the base portion of the pre-pressurize member resiliently maintains deflection of the arm of the seal member.

In a preferred embodiment of the seal device for painting machine according to the present invention, the seal ring has in cross section across the groove a substantially tuning fork shape with a pair of opposed arms of substantially the same shape at both sides of the groove. The groove in the seal ring is substantially a composite UV-shape in cross section having a substantially U-shape portion followed by a substantially V-shape portion.

In another embodiment of the seal device for painting machine according to the present invention, the seal ring has in cross section across the groove a first arm substantially parallel with the center axis and a second arm extending from the first arm in a slanted manner toward the center axis. The groove in the seal ring is substantially U-shape slanted toward the center axis.

The seal ring is made from polytetrafluoroethylene and the pre-pressurize member is made from synthetic rubber. A plurality of seal devices each comprising the seal ring and the pre-pressurize member are disposed in stacking with one another. The seal device for painting machine further comprises a pressure adjusting member for externally adjusting the pressure to be applied to the pre-pressurize member.

The seal device for painting machine according to the present invention has the following advantage in practical use. That is, unlike the conventional V-seal in which the adaptor made from a relatively hard material inserted into the groove in the seal ring for simply supporting or holding it, the seal device according to the present invention utilizes the pressure member made from a relatively high resilient material such as synthetic rubber or the like and the base portion of the pressure member is filled in the groove of the seal ring for resiliently supporting the arms at both sides of the groove in the seal ring, thereby achieving about 5 millions painting operations as compared to up to about 1 million painting operations of the conventional seal device.

Moreover, the use of particular constructions in the sealing ring to have a generally composite UV-shaped groove and a pair of opposed arms of substantially the same shape at both sides of the groove in cross section or the first arm substantially parallel to the center axis and the second arm extending from the first arm in a slanted manner toward the center axis with a generally U-shaped groove between the arms helps to outwardly deflect the free ends of the arms with relatively small pressure when pressure is applied to the pre-pressurize member, thereby achieving high sealing performance. Also, the selection of proper characteristics as the materials for the seal ring and the pre-pressurize member and the use of a plurality of seal devices each comprising the seal ring and the pre-pressurize member in tandem manner enhance the sealing performance, especially durability and pressure resistance.

Additionally, a pressure adjustment member for properly adjusting the pressure to the pre-pressurize member may be used at proper timing in the long time of painting operations for improving sealing performance and durability of the seal device.

### BRIEF DESCRIPTION OF THE DRAWINGS

FIG. 1 is a cross section view of a first embodiment of the seal device for painting machine according to the present invention;

FIG. 2 is a schematic to describe the actual use of the seal device for painting machine as shown in FIG. 1;

FIG. 3 is a cross section view of a major part of a painting machine using a second embodiment of the seal device for painting machine according to the present invention;

FIG. 4 is a magnified cross section view for describing the seal device as shown in FIG. 3;

FIG. 5 is a schematic to show the entire construction of a typical painting machine;

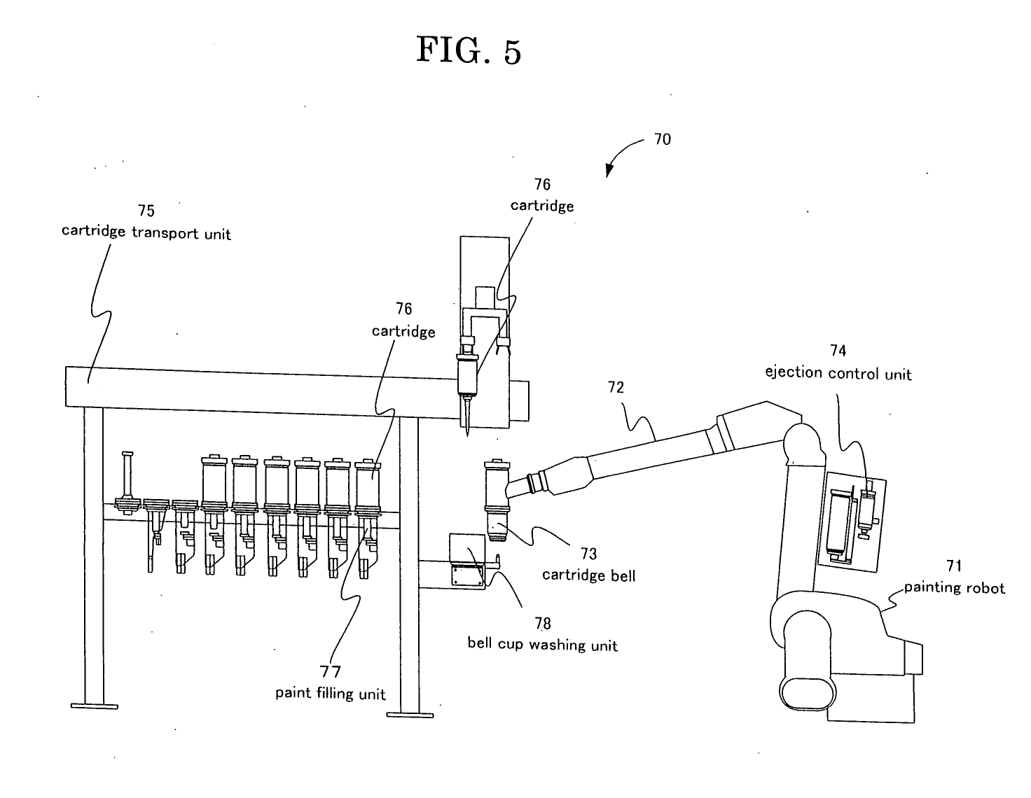

FIG. 6 is a diagram for describing the painting operation of the painting machine as shown in FIG. 5; and

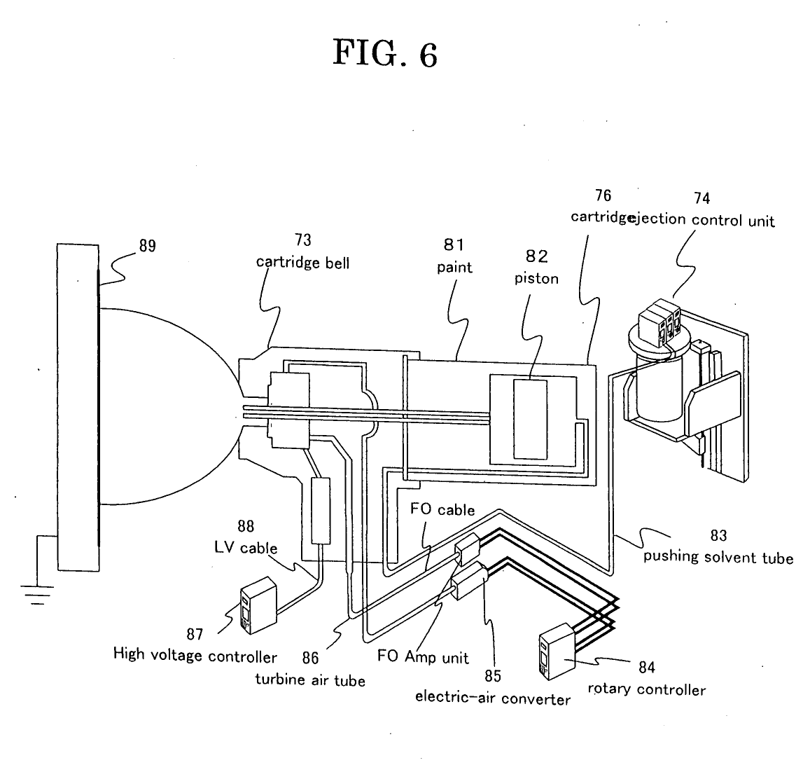

FIG. 7 is a conventional seal device for painting machine; wherein (A) is a cross section view of the seal ring, (B) is a cross section view of the adaptor and (C) is a cross section view of the seal ring and the adaptor in the condition of actual use.

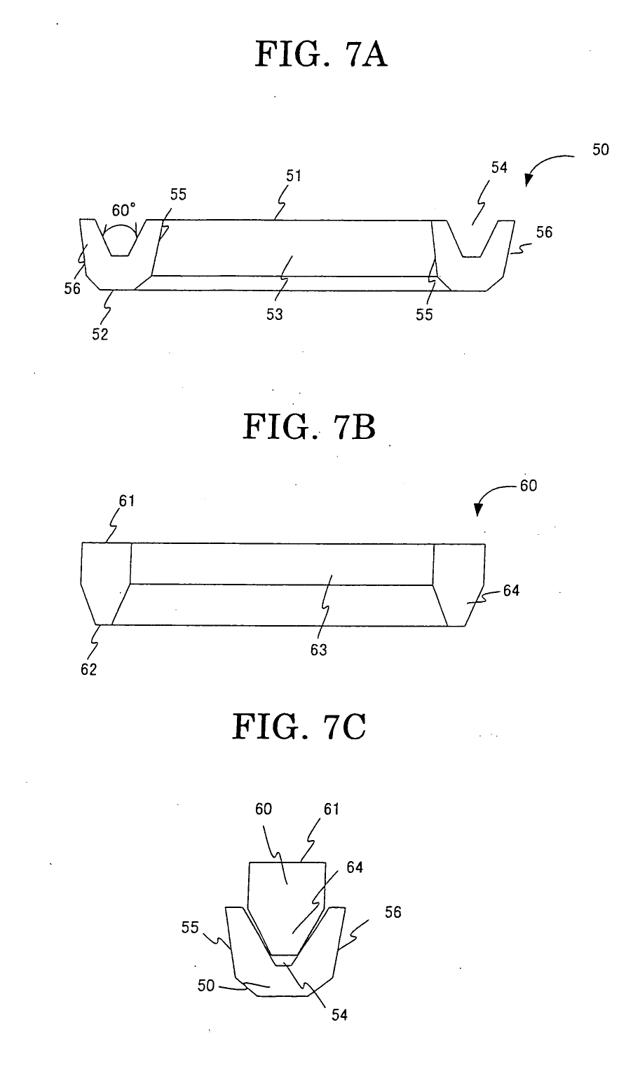

### DESCRIPTION OF PREFERRED EMBODIMENTS

Now, construction and operation of preferred embodiments of the seal device for painting machine according to the present invention will be described hereunder with reference to the accompanying drawings.

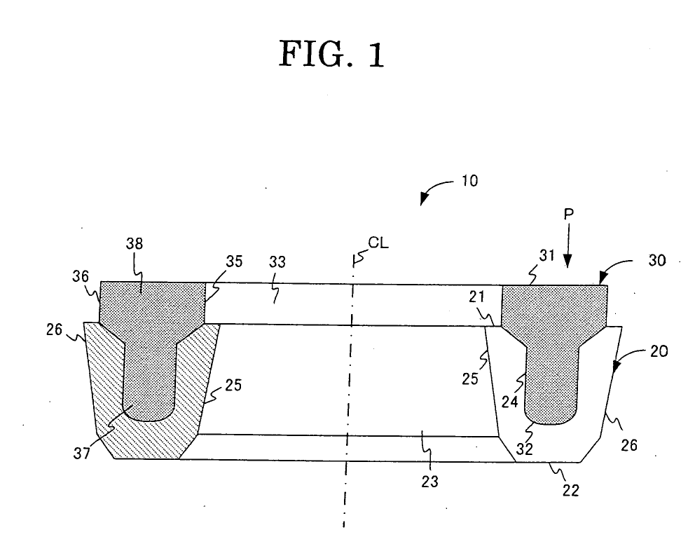

Firstly, a reference is made to FIG. 1 that is a cross section view along the centerline of a first embodiment of the seal device for painting machine according to the present invention in an assembled condition. The seal device for painting machine (referred to simply as the seal device below) 10 comprises a seal ring 20 and a pre-pressurize member 30. Although the seal ring 20 and the pre-pressurize member 30 are separately made from different materials to be described hereinafter, they are assembled together or integrated with each other as shown in FIG. 1 in a condition of actual use.

The seal ring 20 has circular upper surface 21 and bottom surface 22 and also an opening 23 aligned with the centerline CL or the centers of the upper surface 21 and the bottom surface 22. As a result, the seal ring 20 is a generally ring-shape (or doughnut-shape) having the upper surface 21 and the bottom surface 22 and a deep groove 24 is formed in the upper surface at the circumference toward the bottom surface 22.

The groove 24 is substantially U-shape at the lower portion and substantially V-shape at the upper portion, thereby a composite UV-shape (or substantially U-shape with tapered at the upper portion) in cross section view as shown in FIG. 1. This makes the cross sectional view of the seal device 20 substantially tuning fork shape (or a U-shape) having a pair of right and left arms 25 and 26 of substantially equal size and shape at both sides of the groove. The outer surfaces of these arms 25 and 26 are sloped to expand slightly outwardly toward the upper portion or the upper surface 21 of the seal ring 20. Additionally, there is formed a tapered portion at the outer circumference near the bottom surface 22. It is to be noted that the inner side surface of the arm 25 (opposite to the groove 24) of the seal ring 20 is designed to slidably contact with a reciprocating shaft (or a tubular member) of a painting machine and constitutes a sealing surface to seal fluid material of a painting machine while the outer side surface of the arm 26 constitutes a sealing surface that abuts against an inner wall of a casing (for example, a cartridge or the like) as will be described hereinafter.

Preferably, the seal ring 20 is made from a flexible material by molding technology. The seal ring 20 is required to have low friction characteristic as well as excellent chemical stability. Although a preferable material for the seal ring is polytetrafluoroethylene (PTFE), it is more preferable that an appropriate amount of carbon fiber such as carbon black or the like is uniformly filled in such flexible material in order to improve durability.

On the other hand, the pre-pressurize member 30 is made from a relatively highly resilient material. The pre-pressurize member 30 has an upper surface 31, a bottom surface 32 and a center opening 33 and is a ring having the diameter smaller than that of the seal ring 20. And the pre-pressurize member 30 comprises a base portion 37 having an inner side surface 35 and an outer side surface 36 to provide a cross sectional shape substantially corresponding to that of the groove 24 in the seal ring 20 and a pressure portion (or a head portion) 38 above the base portion 37. It is to be noted herein that the technical terms “relatively low resilient” and “relatively high resilient” are used to compare resiliency of the materials of the seal ring 20 and the pre-pressurize member 30 and the former means relatively rigid while the latter means highly resilient.

A preferred material for the pre-pressurize member 30 is fluoric synthetic rubber. When used as the seal device for painting machine 10, the base portion 37 of the pre-pressurize member 30 is pressed into the groove 24 in the seal ring 20 as shown in FIG. 1, thereby integrating the seal ring 20 and the pre-pressurize member 30 with each other. Under this condition, the pressure portion (or head portion) 38, or the upper surface 31 of the pre-pressurize member 30 extend upwardly from the upper surface 21 of the seal ring 20 by the predetermined distance. When used in a painting machine, the pre-pressurize member 30 is pre-pressured by applying appropriate force onto the generally flat upper surface 31 of the pressure portion 38 toward the groove 24 in the seal ring 20 as will be described hereinafter.

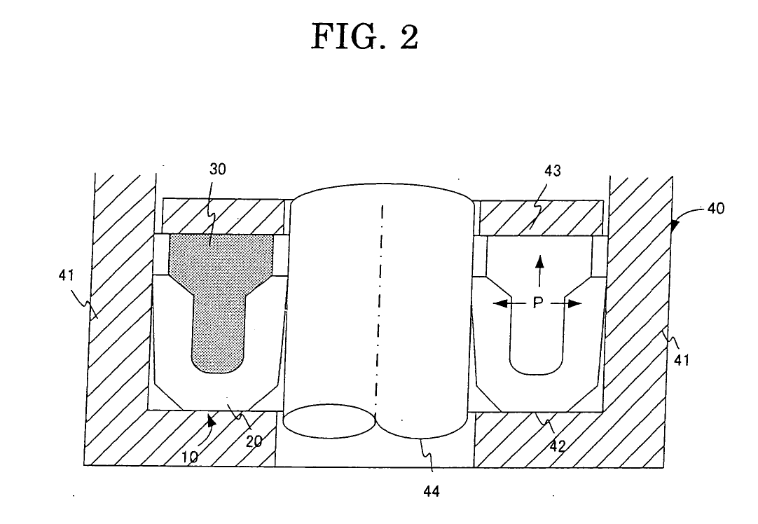

Now, reference is made to FIG. 2 that is a diagram for describing the seal device for painting machine as shown in FIG. 1 used in a painting machine. The seal device 10 is disposed in a space between left and right sidewalls 41 of a casing 40 of the painting machine, a first member (for example, a bottom surface of the casing 40) 42 and a second member (for example, a push-down lid) 43. That is, the bottom surface 22 of the seal ring 20 of the seal device 10 contacts with the upper surface of the first member 42 of the casing 40 and the upper surface 31 of the pre-pressurize member 30 contacts with the bottom surface of the second member 43 of the casing 40. The outer side surface (or the outer sidewall) of the arm 26 of the seal ring 20 constituting the seal device 10 makes contact with the inner surface of the sidewall 41 of the casing 40. Furthermore, the shaft 44 that reciprocates in response to the painting operation of the painting machine extends through the opening 23 of the seal ring 20 and the opening 33 of the pre-pressurize member 30 of the seal device 10 and the outer side surface of the arm 25 of the seal ring 20 constituting the seal device 10 makes contact with the outer surface of the shaft 44 of the painting machine. The shaft 44 is,for example, a metal tubular member that reciprocates with respect to the casing 40.

By the construction as shown in FIG. 2, upon application pressure P on the upper surface 31 of the pre-pressurize member 30 of the seal device 10 (by way of, for example, push-down lid 43), a force is applied onto the both sides of the groove 24 of the seal ring 20, that is the left and right arm portions of the tuning fork in cross section are forced to bend outwardly. And the base portion 37 of the pre-pressurize member 30 develops counter force of the above force onto the arm portions by its resiliency. As a result, the seal device 10 provides smooth and firm closure (or sealing) between the reciprocating shaft 44 and the inner wall of the casing 40. That is, the seal device 10 is able to surely seal the paint that is oily or aqueous fluid containing slurry of acidic or alkaline solvent, pigment, mica particles, aluminum foils and the like, thereby preventing it from leaking. Since the seal ring 20 is made from a material having low friction characteristic as described hereinabove, a stable sealing is ensured even if the shaft 44 may reciprocate inside the casing 40 (i.e., mutual movement between the shaft 44 and the casing 40).

It is to be noted that the cross sectional shape of the groove 24 in the seal ring 20 is generally composite UV-shape as described hereinabove, the pressure applied to the pressure portion 38 of the pre-pressurize member 30 is largely applied to the end portions (i.e., free ends) of the arms 25 and 26. This ensures to form seal lips (or sealing surfaces) for making contact with the shaft 44 and the inner surface of the casing 41.

By taking the construction and choosing appropriate materials as described hereinabove, experiments demonstrate that the seal device of the particular embodiment according to the present invention can maintain excellent sealing performance before and after about 5 million painting operations (i.e., reciprocal movements of the shaft 44). Because of such excellent sealing performance, the seal device is able to significantly reduce maintenance operations of the painting machine using such seal device, effectively prevent paint or the like from leaking and significantly improve painting efficiency, thereby leading to significant reduction of the painting cost.

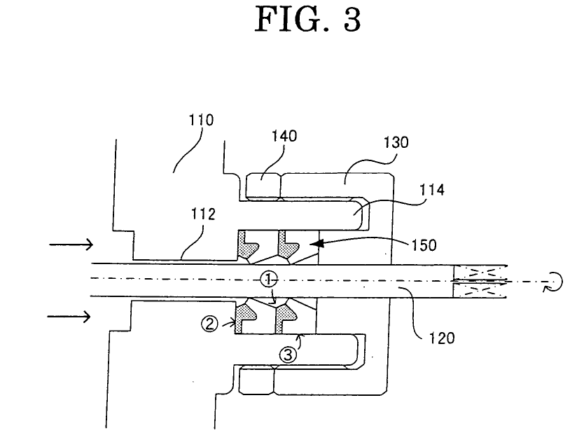

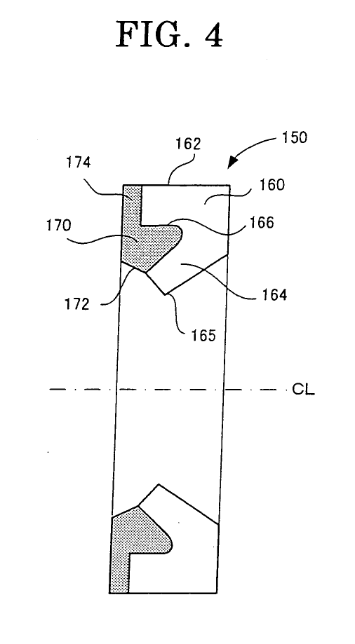

Now, a second embodiment of the seal device for painting machine according to the present invention will be made with reference to FIG. 3 and FIG. 4. FIG. 3 is a cross section view of a major portion of a painting machine to show how the seal device for painting machine is incorporated. FIG. 4 is a magnified cross section view of the seal device. It is to be noted, however, that the center portion may not be equally sized with respect to the circumferential sealing portion for convenience of illustration.

Firstly, as shown in FIG. 3, an opening 12 is formed in a portion of a pump main body 110 of a painting machine from a fluid (for example, paint) side at the left side toward an atmospheric side at the right side in FIG. 3. A rotary shaft (or cylinder) 120 for a painting machine extends through the opening 112. Moreover,the pump main body 110 is formed with a cylindrical portion 114 around the opening 112 to extend toward the atmospheric side. The cylindrical portion 114 has a larger inner diameter than the diameter of the opening 112 so as to form a seal accommodation portion 116 and is formed with a screw (not shown) on the outer surface.

The seal accommodation portion 116 is designed to dispose he seal device 150. In the particular embodiment as shown in Fig. 3, a pair of seal devices 150 are disposed in stacking with each other. A seal pushing cap 130 is screwed onto the cylindrical portion 114 by way of, for example, a washer 140. As a result, an appropriate pressure is applied to the seal device 150 as disposed between the outer surface of the pump main body 110 and the inner surface of the seal pushing cap 130 in the seal accommodation portion 116 inside the cylindrical portion 114.

Now, the seal device 150 will be described in greater detail with reference to FIG. 4 together with FIG. 3. As shown in FIG. 4, each seal device 150 comprises a seal ring (or a main body) 160 that is made from relatively low resilient material, preferably, for example, polytetrafluoroethylene or the like and a pre-pressurize member 170 to be used in combination with the seal ring 160. The pre-pressurize member 170 is an elastic member that is made from a relatively high resilient material, preferably, for example, fluoric synthetic rubber. The seal ring 160 and the pre-pressurize member 170 are formed with center openings so that the rotary shaft 120 as shown in FIG. 3 can extend therethrough.

The seal ring 160 has a ring shape as its name implies and has a cross sectional shape comprising a first arm 162 locating at the outer periphery and substantially parallel with the axis and a second arm 164 that extends inwardly (i.e., toward the center axis) from the first arm 162 thereby leaving a substantially U-shaped groove 166 slanted toward the center axis between the first arm 162 and the second arm 164. As a result, the outer circumference of the seal ring 160 has a substantially “ [symbol] ”-shape in cross section. And the free end portion of the second arm 164 constitutes a seal lip (or a sealing surface) 165 that makes contact with the outer surface of the rotary shaft 120.

On the other hand, the pre-pressurize member 170 comprises a main portion (or a base portion) 172 having a shape to fit the substantially U-shaped groove 166 in the seal ring 160 and a pressure portion 174 extending outwardly from the main portion 172. When the seal ring 160 and the pre-pressurize member 170 are compressed in their axial direction between the outer surface of the pump main body 10 and the inner surface of the seal pushing cap 130 in the condition where the main portion 172 of the pre-pressurize portion of the pre-pressurize member 170 is inserted into the substantially U-shaped groove 166, the compressing force applied to the pre-pressurize member 170 pushes the second arm 164 inwardly (or to the direction toward the rotary shaft 120), thereby deflecting the seal lip portion 165 at the end the second arm 164 to be pressed onto the outer surface of the rotary shaft 120. In this manner, the highly pressurized fluid (or paint) is effectively prevented from leaking from the fluid side to the outside or the atmospheric side through the opening 112 in the pump main body 110 (i.e., providing complete sealing).

Now, a special attention should be paid to the fact that the second arm 164 of the seal ring 160 is slanted toward the center axis or the rotary shaft 120 and the main portion (or the base portion) 172 of the pre-pressurize member 170 is inserted into the substantially U-shaped groove 166. When a pressure is applied to the pressure portion 174 of the resilient pre-pressurize member 170, the pressure primarily deflect the second arm 164 of the seal ring 160 toward the rotary shaft 120 in a resilient manner. And the deflection of the second arm 164 is resiliently maintained so that the seal lip 165 at the end provides a resilient contact pressure onto the rotary shaft 120. As a result, the seal lip 165 is able to provide an excellent sealing between the inside (i.e., the fluid side) and the outside (i.e., the atmospheric side) of the pump main body 110 over a long time and even after a large number of painting operations.

It is to be noted that the use of a plurality of seal devices 150 (for example, 2 seal devices in the particular embodiment) in stacking manner as shown in FIG. 3 is able to provide more reliable sealing. It is possible here that an appropriate pressure is applied to the pre-pressurize member 170 by adjusting the screw rotation of the seal pushing cap 130. Also, it is possible to further screwing the seal pushing cap 130 for readjusting the pressure of the pre-pressurize member 170 whenever the sealing performance is deteriorated as a result of a large number of painting operations. As a result, the seal pushing cap 130 has the function as a pressure adjusting member.

Although construction and operation of preferred embodiments of the seal device for painting machine according to the present invention have been described in detail hereinabove, it is to be noted that such embodiments are nothing but examples of the present invention and are not demonstrated for restricting the present invention. It is a matter of course that a person having an ordinary skill in the art is able to make various modifications depending on particular applications without departing from the scope and spirit of the present invention. For example, the circumferential shape of the seal ring and the pre-pressurize member is not necessarily circular. It is also possible to use more than two seal devices each comprising the seal ring and the pre-pressurize member in a stacking manner (or in tandem) for particular applications. Moreover, the seal device for painting machine can be applied not only to the cartridge type painting machines but also to various other types of painting machines.

What is claimed is:

1. A seal device for painting machine for painting an object to be painted by spraying paint from a container for such paint by way of a moving shaft and comprising a seal ring having an opening through which the shaft extends and a pre-pressurize member to be inserted into a groove in the seal ring, characterized in that:
the seal ring is made from a material of relatively low resilient and low friction characteristics and is formed with a pair of arms at both sides of the groove in cross section across the groove; the pre-pressurize member is made from a relatively high resilient material and has a base portion to be inserted into the groove in the seal ring and a pressure portion extending from the seal ring; and the base portion of the pre-pressurize member resiliently maintains deflection of the arm of the seal ring.

2. A seal device for painting machine of claim 1, wherein the seal ring has the cross sectional shape across the groove of substantially tuning fork shape having a pair of opposed arms of substantially the same shape at both sides of the groove.

3. A seal device for painting machine of claim 2, wherein the cross sectional shape of the groove in the seal ring is substantially composite UV-shape of a substantially U-shape portion followed by a substantially V-shape portion.

4. A seal device for painting machine of claim 1, wherein the seal ring has a cross sectional shape across the groove of a first arm substantially parallel with the center axis and a second arm extending from the first arm in a slanted manner toward the center axis.

5. A seal device for painting machine of claim 4, wherein the groove in the seal ring is substantially U-shape slanted toward the center axis.

6. A seal device for painting machine of either one of claims 1-5, wherein the seal ring is made from polytetrafluoroethylene and the pre-pressurize member is made from synthetic rubber.

7. A seal device for painting machine of either one of claims 1-6, wherein a plurality of seal devices each comprising the seal ring and the pre-pressurize member are disposed in stacking with one another.

8. A seal device for painting machine of either one of claims 1-7, further comprising a pressure adjusting member for externally adjusting the pressure to be applied to the pre-pressurize member.
